(19) United States
(12) Patent Application Publication
(10) Pub. No.: US 2004/0211505 A1
(43) Pub. Date: Oct. 28, 2004

(54) Wearing of an adhesive reflective tape handicapped logo on any garment to protect the person from injury of vehicular or pedestrian traffic by day or night

(76) Inventor: Frederick Vincent Hrachovina, Venice, FL (US)

Correspondence Address: Frederick Vincent Hrachovina, 1238 Lucaya Avenue, Venice, FL, 34292, US

(21) Appl. No.: 10/421,416

(22) Filed: Apr. 23, 2003

(51) Int. Cl. B44C 1/00

(52) U.S. Cl. 156/63

(57) ABSTRACT

The new use of the handicapped logo. Made of adhesive reflective tape of various colors, sizes, widths, and lengths. Worn on any garment, as over the chest and abdomen and on the back of the person. This provides a visible protective shield from vehicular or pedestrian traffic by day or night.

### CROSS-REFERENCE TO RELATED APPLICATION

NOT APPLICABLE

### FEDERALLY SPONSORED RESEARCH

NOT APPLICABLE

### SEQUENCE LISTING OR PROGRAM

NOT APPLICABLE

### BACKGROUND OF THE INVENTION—FIELD OF INVENTION

This invention relates to a new use for the handicapped logo.

### BACKGROUND OF THE INVENTION

The handicapped logo has been used on buildings in parking spaces for vehicular traffic.

The drawings of which are the same across these United States of America.

### SUMMARY

My invention provides a new use for the handicapped logo. The wearing of an adhesive reflective tape handicapped logo on any garment to protect the person from injury of vehicular or pedestrian traffic by day or night.

I claim:

1. a. the wearing on any garment of the handicapped logo,
b. made of adhesive reflective tape in various colors, sizes, widths, and lengths,
c. worn over the chest and abdomen and on the back of the person,
d. to provide a visible protective shield,
e. from vehicular or pedestrian traffic by day or night.
